(19) United States
(12) Patent Application Publication
(10) Pub. No.: US 2018/0338635 A1
(43) Pub. Date: Nov. 29, 2018

(54) ORNAMENT MOUNTING SYSTEM AND METHOD

(71) Applicant: Michael Thompson, Slaton, TX (US)

(72) Inventor: Michael Thompson, Slaton, TX (US)

(21) Appl. No.: 15/989,122

(22) Filed: May 24, 2018

Related U.S. Application Data
(60) Provisional application No. 62/510,702, filed on May 24, 2017.

(51) Int. Cl. A47G 33/10; F16M 13/02; F21V 21/108; F21V 21/088

(52) U.S. Cl. CPC A47G 33/10; F16M 13/022; F21Y 2115/10; F21V 21/088; F21V 21/108

(57) ABSTRACT

An ornament mounting system and method; the ornament mounting system having small see-through shelves capable of supporting heavier ornaments and decorations. It supports heavy items in order to prevent tree branches from sagging and hanging down, looking unsightly. The device attaches to the truck of the Christmas tree, extending outward to support items on the branches. This further eliminates the worry of heavy ornaments falling, breaking, and requiring replacement.

### CROSS REFERENCE TO RELATED APPLICATION

The present application is related to and claims priority to U.S. Provisional Patent Application No. 62/510,702 filed May 24, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of ornament display means and more specifically relates to an ornament mounting system and method.

### 2. Description of Related Art

Many people celebrate holidays as festive events. People, for example at Christmas, may enjoy hanging ornaments from a Christmas tree. Heavier gifts and items are not easily supported from the branches of a Christmas tree. If the item is too heavy, branches can sag and droop. Some branches may even end up breaking dropping the fragile gift/ornament on the ground. Some items may fall and get lost in the middle of the tree, forcing an individual to look through the lights and decorations. A suitable solution is desired.

U.S. Pat. No. 5,071,098 to Robert E. Aldridge relates to Christmas tree ornament shelf assemblies. The described Christmas tree ornament shelf assemblies including a platform having a top surface on which an ornament is arranged to be seated. This platform is used on laterally extending arms which hold the lower ornaments and is also used on a top mount. In each case, the platform is supported by the trunk of the tree whereby to provide a good solid support for ornaments. The laterally extending arms have adjustment structure therein to position the platform in suitable positions relative to the tree. Each of the laterally extending arms and the top assembly are held in position by a Velcro-type band extending around the tree trunk.

### BRIEF SUMMARY OF THE INVENTION

In view of the foregoing disadvantages inherent in the known ornament display means art, the present disclosure provides a novel ornament mounting system and method. The general purpose of the present disclosure, which will be described subsequently in greater detail, is to provide small shelves capable of supporting heavier ornaments and decorations. The present invention supports heavy items in order to prevent tree branches from sagging and hanging down causing the tree to look unsightly. This device attaches to the (substantially) cylindrical truck of the Christmas tree, extending outward to support items on the branches. The apparatus further eliminates the worry of heavy ornaments falling, breaking, and requiring replacement. The present invention prevents gifts from falling through the tree and getting lost.

An ornament mounting system and method is disclosed herein. The ornament mounting system and method in a first embodiment comprising: at least one ornament mounting assembly, each ornament mounting assembly including at least one non-extending arm; a shelf; and an attacher (preferably comprising a clamp; and a fastener). Other suitably equivalent fastening means may be used. Each at least one ornament mounting assembly comprises the attacher, the at least one non-extending arm, and the shelf in a series relationship and in functional combination. The attacher is configured to engage about a cylindrical-trunk of a Christmas tree (for use); wherein each at least one ornament mounting assembly is clamp-mountable to extend laterally from the cylindrical-trunk of the Christmas tree such that at least one decorative ornament is able to be positioned on the shelf for display.

A second embodiment of the ornament mounting system comprises: at least one ornament mounting assembly, each ornament mounting assembly including; at least one extendable-arm; a shelf; and an attacher.

A method of using the ornament mounting system and method is also disclosed herein. The method of using the ornament mounting system and method may comprise the steps of: providing an ornament mounting system, the ornament mounting system comprising: at least one ornament mounting assembly, each ornament mounting assembly including at least one extendable-arm (or non-extendable-arm); a shelf; and an attacher comprising a clamp and a fastener; engaging each of the at least one ornament mounting assemblies via a respective attacher along a length of a cylindrical-trunk of a Christmas tree such that mounted at least one ornament mounting assemblies follow a (general) contour of the Christmas tree from top to bottom (branches getting smaller as approaching the top of the tree); and displaying at least one decorative ornament on a respective shelf.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an ornament mounting system and method, constructed and operative according to the teachings of the present disclosure.

FIG. 1 is a front perspective view of the ornament mounting system and method during an ‘in-use’ condition, according to an embodiment of the disclosure.

FIG. 2 is a front perspective view of the ornament mounting system and method of FIG. 1, according to an embodiment of the present disclosure.

FIG. 3 is a front perspective view of the ornament mounting system and method of FIG. 1, according to an embodiment of the present disclosure.

FIG. 4 is a front perspective view of the ornament mounting system and method of FIG. 1, according to an embodiment of the present disclosure.

FIG. 5 is a flow diagram illustrating a method of use for the ornament mounting system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an ornament display means and more particularly to an ornament mounting system and method as used to improve the efficient and effective display of heavy ornaments.

Generally, the apparatus comprises ‘tree shelves’ which are adjustable support shelves capable of holding up heavy ornaments and gifts on a Christmas tree. The device can include an adjustable arm brace with a clamping or clip system supporting a tray at the end of the brace. The clip or clasp system can be installed on the pole or trunk of the Christmas tree (real or natural). Some versions may include LED lights to add decoration to the Christmas tree. Each tray is capable of supporting heavier ornaments and gifts on the tree. The shelves prevent tree branches from sagging and breaking, allowing users to place items on the tree without undue worry. The shelves can be adjusted and moved with ease. The tree Shelves can be constructed using metal, plastic, and other suitable materials. The shelves may be available in various sizes in order to accommodate all user needs and preferences. Exact size, measurement, construction, and design specifications may vary upon manufacturing.

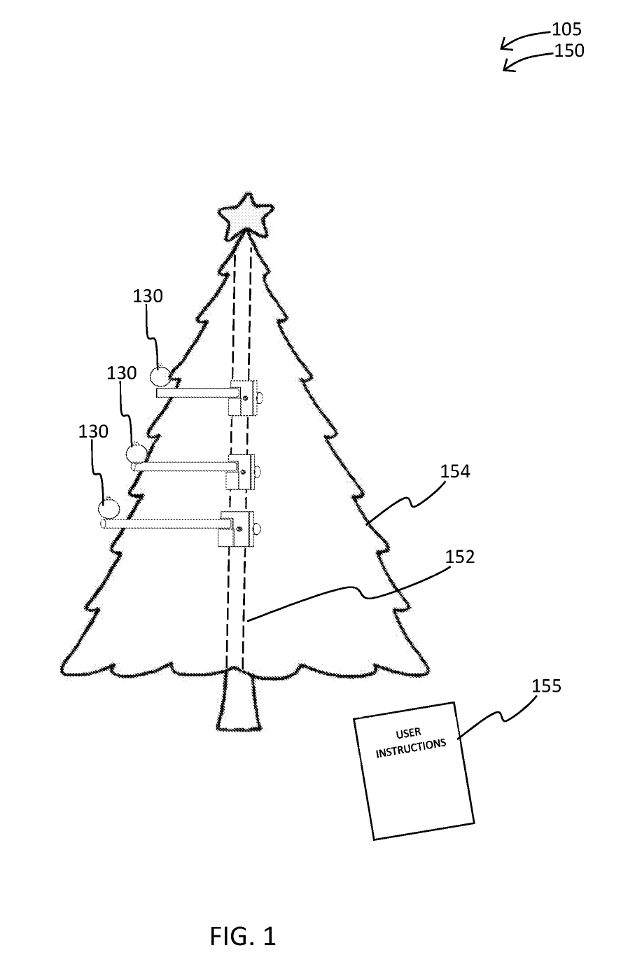

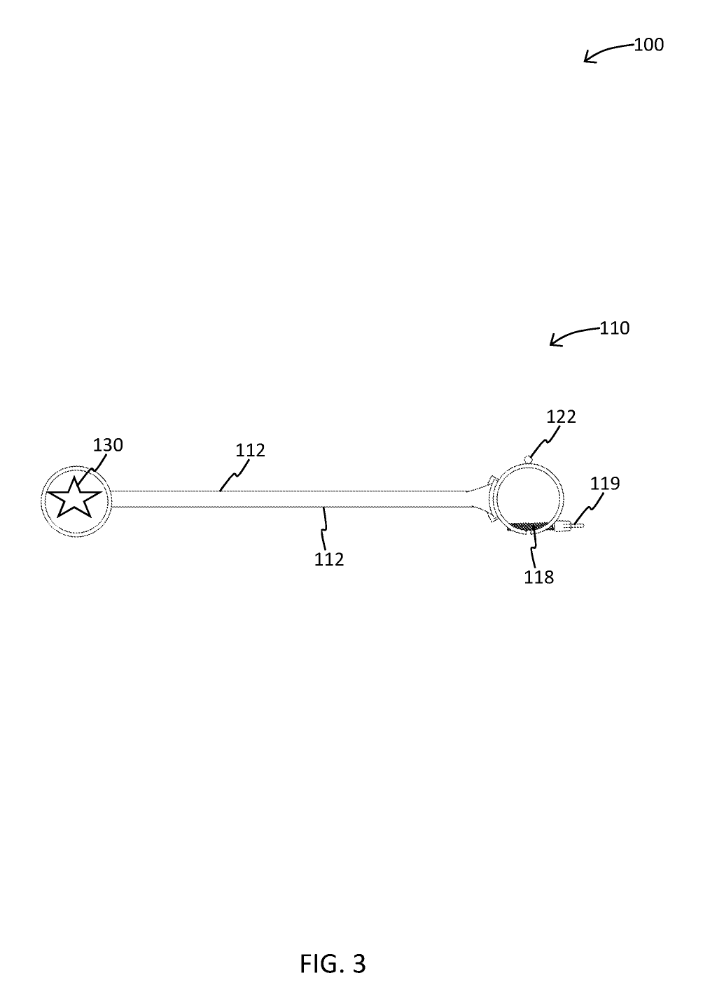

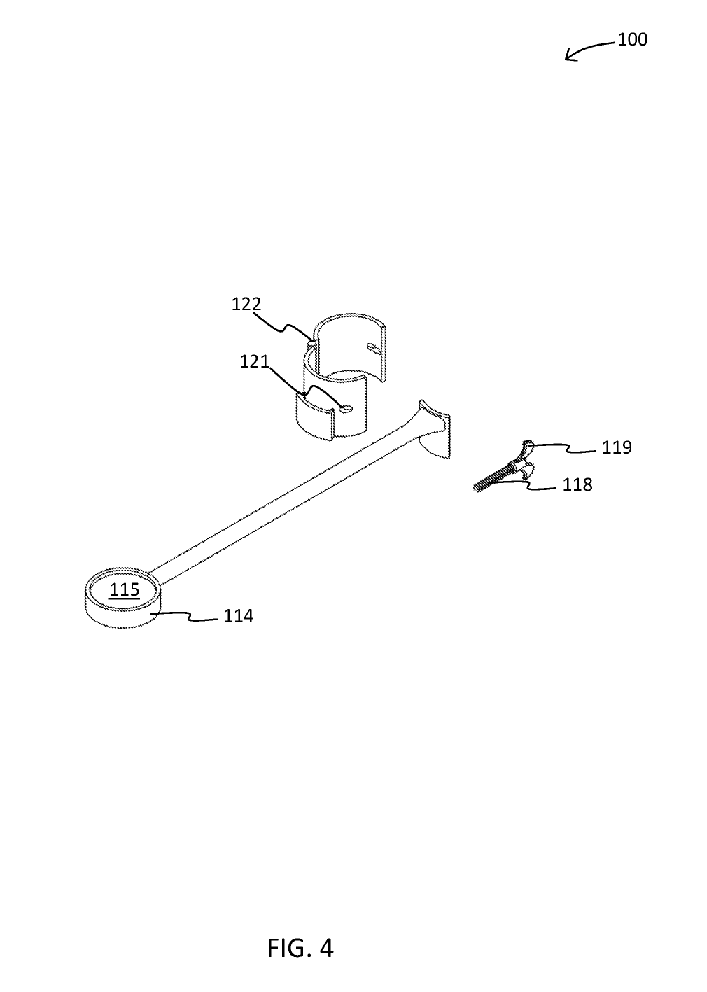

Referring now more specifically to the drawings by numerals of reference, there is shown in FIGS. 1-4, various views of an ornament mounting system and method 100. FIG. 1 shows an ornament mounting system and method 100 during an ‘in-use’ condition 150, according to an embodiment of the present disclosure. As Illustrated, the ornament mounting system and method 100 may include at least one ornament mounting assembly 110, each ornament mounting assembly 110 including at least one non-extending arm 112; a shelf 114; and an attacher 116 comprising a clamp 117; and a fastener 118; wherein each at least one ornament mounting assembly 110 comprises the attacher 116, the at least one non-extending arm 112, and the shelf 114 in series and functional combination.

The attacher 116 is configured to engage about a cylindrical-trunk 152 of a Christmas tree 154. Each at least one ornament mounting assembly 110 is clamp-mountable to extend laterally from the cylindrical-trunk 152 of the Christmas tree 154 such that at least one decorative ornament 130 is able to be positioned on the shelf 114 for display. The shelf 114 in preferred embodiments comprises a transparent base 115 such that a ‘lighted’ at least one decorative ornament(s) 130 is/are able to illuminate therethrough.

The clamp 117 comprises two arcuate members 120 able to rotate in relation to each other about a hinge 122 such that the ornament mounting assembly 110 is able to be engaged about the cylindrical-trunk 152 via the fastener 118, when thread-fastened and disengaged from the cylindrical-trunk 152 when not ‘thread-fastened’. Other fastening means may be used. The at least one non-extending arm 112 (non-extending embodiment) comprises exactly two of the at least one non-extending arms 112. The fastener 118 preferably comprises a wing-nut-end 119 for ease of manipulating the fastener 118. In certain embodiments the ornament mounting assembly 110 comprises LED-illuminating means. Those with ordinary skill in the art will now appreciate that upon reading this specification and by their understanding the art of providing illumination via LED or other lighting means as described herein, methods of powering, placement, etc., will be understood by those knowledgeable in such art.

The at least one ornament mounting assembl(ies) 110 comprise a plurality of the at least one ornament mounting assembl(ies) 110, each of the at least one ornament mounting assembl(ies) 110 having a different length such that the plurality of the at least one ornament mounting assembl(ies) 110 are able to be placed to match a contour of the branches of the Christmas tree 154, each being a different length (decreasing in length, as mounted, when approaching a top of the Christmas tree 154). In this embodiment the length of the at least one ornament mounting assembl(ies) 110 may range as to what is reasonable length of the branches so as to properly display the at least one decorative ornament(s) 130. The at least one decorative ornament 130 may comprise a gift or other such shelvable decorative item.

In embodiments having exactly two of the at least one non-extending arms 112, these non-extending arms 112 are preferably located on a common horizontal plane; wherein the common horizontal plane is located perpendicular to the cylindrical-trunk 152 when mounted (and parallel to a floor surface). The hinge 122 is vertical (substantially parallel to the cylindrical-trunk 152) when the ornament mounting assembly 110 is mounted.

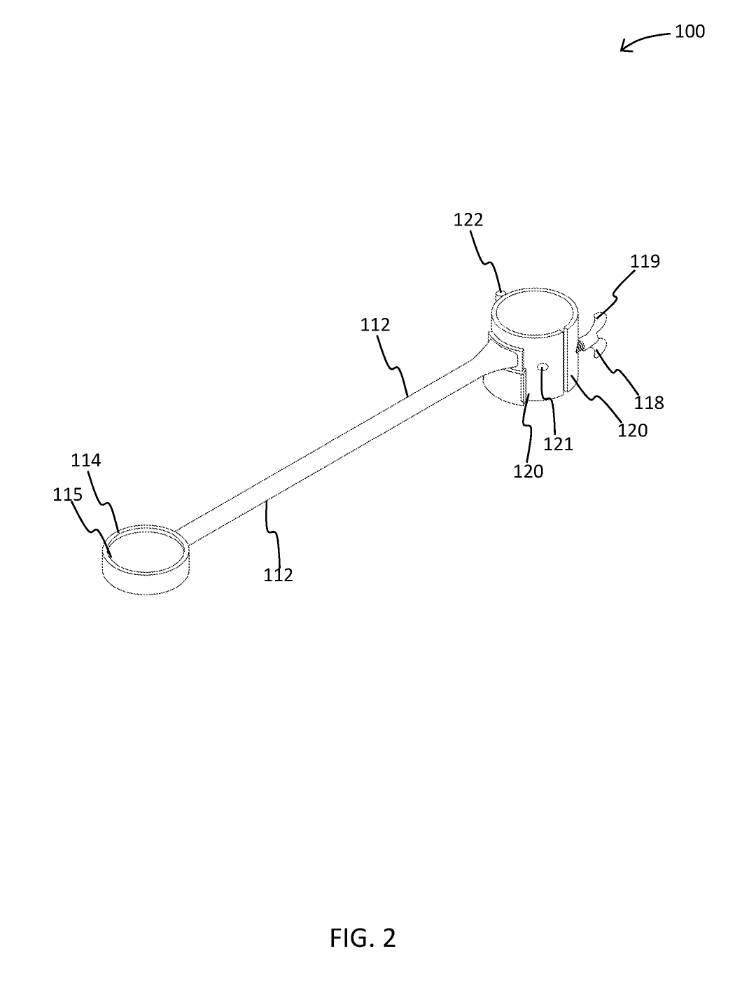

FIG. 2 shows a front perspective view of the ornament mounting system and method 100 of FIG. 1, according to an embodiment of the present disclosure. According to an alternate embodiment the ornament mounting system and method 100 may include at least one ornament mounting assembly 110, each ornament mounting assembly 110 including at least one extendable-arm 144; a shelf 114; and an attacher 116 comprising a clamp 117 and a fastener 118; wherein each at least one ornament mounting assembly 110 in this particular embodiment comprises the attacher 116, the at least one extendable-arm 144, and the shelf 114 in a series relationship and in functional combination.

In a similar manner to the previous embodiment the attacher 116 is configured to engage about a cylindrical-trunk 152 of a Christmas tree 154; wherein each at least one ornament mounting assembly 110 is clamp-mountable to extend substantially laterally from the cylindrical-trunk 152 of the Christmas tree 154 such that at least one decorative ornament 130 is able to be positioned on the shelf 114 for display. In these extendable embodiments the extendable-arms 144 may extend telescopically along the two arms and be fastened in place. Those with ordinary skill in the art will now appreciate that upon reading this specification and by their understanding the art of adjusting means and telescoping as described herein, methods of adjusting for length and securely fastening at a desired length will be understood by those knowledgeable in such art. In these embodiments the shelf 114 may also comprise a transparent base 115.

Again, in this embodiment of the ornament mounting system 100, the clamp 117 preferably comprises two arcuate members 120 able to rotate in relation to each other about a hinge 122 such that the ornament mounting assembly 110 is able to be engaged about the cylindrical-trunk 152 via the fastener 118, when thread-fastened and disengaged (opened) from the cylindrical-trunk 152 when not thread-fastened. The two arcuate members 120 each comprise a respective threaded aperture 121. The two arcuate members 120 form a closed periphery when fastened together; wherein the respective threaded apertures 121 are adjacent (each other) when the fastener 118 is engaged through the respective threaded apertures 121 and the clamp 117 is in a ‘closed-condition’ (such as that employed when coupled to the cylindrical-trunk 152). The respective threaded apertures 121 are non-adjacent when the fastener 118 is not engaged through the respective threaded apertures 121 and the clamp 117 is in an open-condition (during non-coupled conditions such as in storage or the like).

The hinge 122 is vertical and allows relative rotation of the two arcuate members 120 about a common vertical axis substantially parallel to the cylindrical-trunk 152 of the Christmas tree 154. According to one embodiment, the ornament mounting system and method 100 may be arranged as a kit. The kit may include a plurality of ornament mounting assemblies 110. The instructions may detail functional relationships in relation to the structure of the ornament mounting system and method 100 (such that the ornament mounting system and method 100 can be used, maintained, or the like, in a preferred manner).

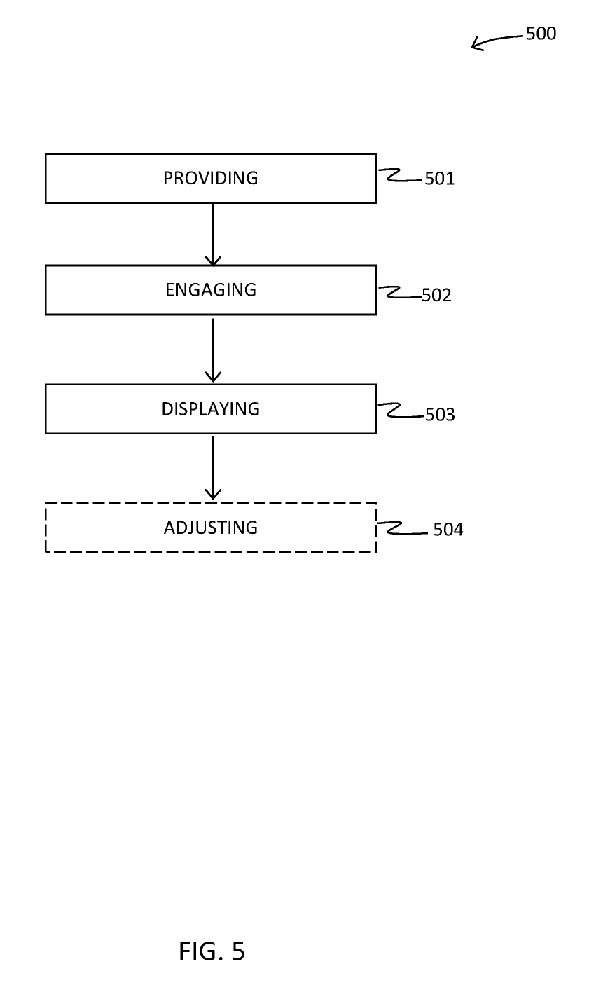

Referring now to FIG. 5, a flow diagram illustrating a method of use 500, according to an embodiment of the present disclosure. As illustrated, the method of use 500 for the ornament mounting system 100 may include the steps of: 501 providing an ornament mounting system 100, the ornament mounting system 100 comprising: at least one ornament mounting assembly, each ornament mounting assembly including; at least one extendable-arm (or non-extendable-arm); a shelf; and an attacher comprising a clamp; and a fastener; 502 engaging each of the at least one ornament mounting assemblies via a respective attacher along a length of a cylindrical-trunk of a Christmas tree such that mounted at least one ornament mounting assemblies follow a (general) contour of the Christmas tree from top to bottom (branches getting smaller as approaching the top of the tree); and 503 displaying at least one decorative ornament on a respective shelf. Certain embodiments may be adjusted as an optional step 504.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for adjusting, etc., ornament mounting system and method 100 such as providing illumination, etc., are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ornament mounting system, the ornament mounting system comprising:
at least one ornament mounting assembly, each said ornament mounting assembly including:
at least one non-extending arm;
a shelf; and
an attacher comprising:
a clamp; and
a fastener;
wherein each said at least one ornament mounting assembly comprises said attacher, said at least one non-extending arm, and said shelf in series and functional combination;
wherein said attacher is configured to engage about a cylindrical-trunk of a Christmas tree; and
wherein each said at least one ornament mounting assembly is clamp-mountable to extend laterally from said cylindrical-trunk of said Christmas tree such that at least one decorative ornament is able to be positioned on said shelf for display.

2. The ornament mounting system of claim 1, wherein said shelf comprises a transparent base such that lighted said at least one decorative ornament(s) are able to illuminate therethrough.

3. The ornament mounting system of claim 2, wherein said clamp comprises two arcuate members able to rotate in relation to each other about a hinge such that said ornament mounting assembly is able to be engaged about said cylindrical-trunk via said fastener, when thread-fastened and disengaged from said cylindrical-trunk when not said thread-fastened.

4. The ornament mounting system of claim 3, wherein said at least one non-extending arm comprises exactly two of said at least one non-extending arms.

5. The ornament mounting system of claim 1, wherein the at least one ornament mounting assembl(ies) comprise a plurality of said at least one ornament mounting assembl(ies), each of said at least one ornament mounting assembl(ies) having a different length such that the plurality of said at least one ornament mounting assembl(ies) are able to be placed to match a contour of said Christmas tree, each said different length decreasing as mounted when approaching a top of the Christmas tree.

6. The ornament mounting system of claim 4, wherein the exactly two of said at least one non-extending arms are located on a common horizontal plane.

7. The ornament mounting system of claim 6, wherein the common horizontal plane is located perpendicular to said cylindrical-trunk when mounted.

8. The ornament mounting system of claim 3, wherein the hinge is vertical when said ornament mounting assembly is mounted.

9. The ornament mounting system of claim 1, wherein the fastener comprises a wing-nut-end.

10. The ornament mounting system of claim 1, wherein the ornament mounting assembly comprises LED-illuminating means.

11. The ornament mounting system of claim 1, wherein the at least one decorative ornament comprises a gift.

12. An ornament mounting system, the ornament mounting system comprising:
at least one ornament mounting assembly, each said ornament mounting assembly including,
at least one extendable-arm;
a shelf; and
an attacher comprising,
a clamp; and
a fastener;
wherein each said at least one ornament mounting assembly comprises said attacher, said at least one extendable-arm, and said shelf in series and functional combination;
wherein said attacher is configured to engage about a cylindrical-trunk of a Christmas tree; and
wherein each said at least one ornament mounting assembly is clamp-mountable to extend laterally from said cylindrical-trunk of said Christmas tree such that at least one decorative ornament is able to be positioned on said shelf for display.

13. The ornament mounting system of claim 12, wherein said shelf comprises a transparent base such that lighted said at least one decorative ornament(s) are able to illuminate therethrough.

14. The ornament mounting system of claim 13, wherein said clamp comprises two arcuate members able to rotate in relation to each other about a hinge such that said ornament mounting assembly is able to be engaged about said cylindrical-trunk via said fastener, when thread-fastened and disengaged from said cylindrical-trunk when not said thread-fastened.

15. The ornament mounting system of claim 14, wherein the two arcuate members each comprise a respective threaded aperture.

16. The ornament mounting system of claim 15, wherein the respective threaded apertures are adjacent when said fastener is engaged through said respective threaded apertures and said clamp is in a closed-condition.

17. The ornament mounting system of claim 15, wherein the respective threaded apertures are non-adjacent when said fastener is not engaged through said respective threaded apertures and said clamp is in an open-condition.

18. The ornament mounting system of claim 15, wherein the hinge is vertical and allows relative rotation of said two arcuate members about a common vertical axis substantially parallel to said cylindrical-trunk of said Christmas tree.

19. The ornament mounting system of claim 12, further comprising set of instructions; and
wherein the ornament mounting system is arranged as a kit.

20. A method of claim use for an ornament mounting system comprising the steps of:
providing an ornament mounting system, the ornament mounting system comprising:
at least one ornament mounting assembly, each said ornament mounting assembly including,
at least one extendable-arm;
a shelf; and
an attacher comprising,
a clamp; and
a fastener;
engaging each of said at least one ornament mounting assemblies via a respective said attacher about a length of a cylindrical-trunk of a Christmas tree such that mounted said at least one ornament mounting assemblies follow a contour of said Christmas tree from top to bottom; and
displaying at least one decorative ornament on a respective said shelf.
